(19) United States
(12) Patent Application Publication
(10) Pub. No.: US 2026/0008216 A1
(43) Pub. Date: Jan. 8, 2026

(54) WATER-COOLING SYSTEM WITH IMPROVED COOLING EFFICIENCY AND INJECTION MOLDING APPARATUS INCLUDING SAME

(71) Applicants: HYUNDAI MOTOR COMPANY, Seoul (KR); Kia Corporation, Seoul (KR)

(72) Inventors: KYUYOUNG LEE, Hwaseong-si (KR); Eu-Ddeum CHOI, Hwaseong-si (KR); YEHUI PARK, Hwaseong-si (KR); JunSik CHOI, Hwaseong-si (KR)

(21) Appl. No.: 18/945,093

(22) Filed: Nov. 12, 2024

(30) Foreign Application Priority Data
Jul. 8, 2024 (KR) 10-2024-0089502

(51) Int. Cl. B29C 45/73; F04C 3/00; B29C 45/17

(52) U.S. Cl. CPC B29C 45/7312; F04C 3/00; B29C 2045/1792

(57) ABSTRACT

A water-cooling system for an injection-molding apparatus is configured to cool a molding mold by circulating cooling water. The water-cooling system includes a cooling channel, a coolant supply pipe, a coolant recovery pipe, and a baffle module. The cooling channel defines a straight flow path inside the molding mold and has a first end that is a channel inlet opened toward an exterior of the molding mold and a second end that defines a transition section and is a closed end of the straight flow path, where the straight flow path extends through at least a part of an interior of the molding mold toward an injection-molded product. The coolant supply pipe supplies the cooling water to the cooling channel. The coolant recovery pipe recovers the cooling water from the cooling channel.

### CROSS-REFERENCE TO RELATED APPLICATIONS

This application is based on and claims priority under 35 U.S.C. 119 to Korean Patent Application No. 10-2024-0089502, filed on July 8, 2024, in the Korean Intellectual Property Office, the disclosure of which is herein incorporated by reference in its entirety.

### TECHNICAL FIELD

The present disclosure relates to a water-cooling system with improved cooling efficiency and an injection molding apparatus including the same. More specifically, the present disclosure relates to a cooling system that induces smooth circulation of cooling water, enabling rapid and uniform cooling of molds, thereby improving the quality and production efficiency of high-precision large injection-molded products such as a hydrogen tank liner, and an injection molding apparatus including the same.

### BACKGROUND

Plastic injection molding technology may be used in various industrial fields. For example, plastic injection molding involves injecting molten plastic resin into a mold to create a product of a predetermined shape.

In some cases, the plastic injection molding process includes injecting, cooling, and ejecting operations. In the injection operation, plastic resin molten at a high temperature is injected into a mold cavity under high pressure, in the cooling operation, the injected resin is cooled and solidified, and in the ejection operation, the solidified product is separated from the mold.

In some cases, the cooling operation has an influence on the final quality and productivity of the product. For instance, if the temperature inside the mold is not uniform or the cooling speed is slow, the product may become deformed, or surface defects may occur. In some cases, for large plastic parts such as hydrogen tank liners, if the cooling efficiency of the mold is low, the time for cooling increases, leading to a decrease in productivity.

In some cases, cooling methods use a relative long path for the cooling water to reach locations close to the product, resulting in a decreased cooling efficiency and an increased resistance to the flow of cooling water.

In some cases, as the temperature of the cooling water may be unevenly distributed inside the mold, the product may be deformed, or defects may occur on the product surface.

In some cases, in a lower mold, the uppermost portion of the cooling water channel formed therein may exhibit a high cooling efficiency as it is the closest to the molded product. In some baffle plate designs, the cooling efficiency at the uppermost portions of the cooling water channels may be often lower.

For example, when the temperature of the upper and lower parts of the mold is not uniform during the manufacturing process of the hydrogen tank liner, the airtightness and durability of the liner may be reduced.

In addition, if the cooling time is prolonged, the production time also increases, leading to decreased productivity and increased manufacturing costs.

### SUMMARY

According to one aspect of the subject matter described in this application, a water-cooling system for an injection-molding apparatus is configured to circulate cooling water to cool a molding mold. The water-cooling system includes a cooling channel that defines a straight flow path inside the molding mold, the cooling channel having (i) a first end that defines a channel inlet opened toward an exterior of the molding mold and (ii) a second end that defines a transition section and is a closed end of the straight flow path, the straight flow path extending through at least a part of an interior of the molding mold toward an injection-molded product, a coolant supply pipe configured to supply the cooling water to the cooling channel, a coolant recovery pipe configured to receive the cooling water from the cooling channel, and a baffle module that is at least partially accommodated inside the cooling channel and defines a circulation path in the cooling channel, the baffle module being configured to move the cooling water introduced through the coolant supply pipe along the circulation path and to discharge the cooling water to the coolant recovery pipe. The baffle module includes a baffle screw that has a cylindrical shape and is accommodated inside the cooling channel along the straight flow path of the cooling channel, the baffle screw including a plurality of thread peak portions that protrude in an oblique direction from an outer periphery of the baffle screw, where the baffle screw is configured to rotate inside the cooling channel to thereby move the cooling water along a predetermined path.

Implementations according to this aspect can include one or more of the following features. For example, the baffle screw may further include a thread contact surface that defines a curved surface spirally extending along an outermost periphery of the plurality of thread peak portions, the thread contact surface being in contact with an inner periphery of the cooling channel, and a thread valley portion that is a groove defined between the plurality of thread peak portions, the thread valley portion defining a spiral flow path between the baffle screw and the inner periphery of the cooling channel.

In some implementations, the baffle screw may define a discharge hole inside the baffle screw, the discharge hole extending along a longitudinal direction of the baffle screw, where the discharge hole provides a flow path that connects opposite ends of the baffle screw to each other. In some examples, the water-cooling system may include a drive module provided outside the cooling channel and configured to generate rotational force, where the baffle module further includes a coupling housing that is configured to close the channel inlet, the coupling hosing defining a pin passing hole and a coolant connection path, and a power transmission pin including (i) a first end coupled to the drive module and (ii) a second end that passes through the pin passing hole and is coupled to the baffle screw accommodated inside the cooling channel, the power transmission pin being configured to transmit the rotational force from the drive module to the baffle screw.

In some implementations, the power transmission pin may define an extension discharge path inside the power transmission pin along the longitudinal direction, where the second end of the power transmission pin is coupled to an end of the baffle screw facing outward of the cooling channel, the extension discharge path being fluidly connected to the discharge hole of the baffle screw. In some examples, the coolant connection path may be connected to the coolant supply pipe and configured to guide the cooling water supplied from the coolant supply pipe into the cooling channel.

In some implementations, the baffle screw may further include a spiral guide that is a spiral groove along an inner periphery of the discharge hole, where a spiral direction of the spiral guide is opposite to a spiral direction of the plurality of thread peak portions. In some implementations, the drive module may include a main driver configured to convert electrical energy into kinetic energy including the rotational force, and a plurality of branch drivers connected to the main driver and configured to receive the rotational force generated by the main driver, where the baffle module is one of a plurality of baffle modules of the water-cooling system. One end of the power transmission pin of each of the plurality of baffle modules may be coupled to a corresponding one of the plurality of branch drivers and configured to be rotated by the rotational force generated by the main driver.

According to another aspect, an injection-molding apparatus includes: one of above-mentioned water-cooling systems; a molding mold equipped with a cavity configured to shape an external shape of the injection-molded product and a base core configured to shape an internal shape of the injection-molded product; a gate which is a passage through which a molten raw material is injected into the space defined between the cavity and the base core; and an ejector configured to separate the injection-molded product from the molding mold. Two or more water-cooling systems may be provided in the molding mold.

In some implementations, a mold is cooled evenly and quickly, which increases cooling efficiency and enhances productivity through a shortened production cycle.

In some implementations, as cooling water circulates more smoothly, the temperature distribution inside the mold is maintained more uniformly, which has the advantage of reducing product deformation and improving product surface quality.

In some implementations, the production precision of large, high-precision injection-molded products such as hydrogen tank liners can be improved, thereby facilitating the manufacture of hydrogen tanks with enhanced airtightness and durability.

In some implementations, as the cooling time is shortened and cooling efficiency is improved, the production cost of products can be reduced.

The effects of the present disclosure are not limited to those mentioned above, and other effects not mentioned will be clearly understood by a person ordinarily skilled in the art from the following description.

### BRIEF DESCRIPTION OF THE DRAWINGS

The above and other aspects, features and advantages of the present disclosure will be more apparent from the following detailed description taken in conjunction with the accompanying drawings.

FIG. 1 is a view schematically illustrating an example of an injection molding apparatus.

FIG. 2 is a schematic cross-sectional view illustrating an example structure of a hydrogen tank installed in a hydrogen vehicle.

FIG. 3 is a cross-sectional view illustrating an example of a water-cooling system.

FIG. 4 is a perspective view illustrating an example of a baffle module in the water-cooling system.

FIG. 5 is an exploded perspective view illustrating an example of a baffle module in the water-cooling system.

FIG. 6 is a cross-sectional view of the baffle module in the water-cooling system.

FIG. 7 is a partial enlarged view of the portion A in FIG. 3.

FIG. 8 is a partial enlarged view of the portion B in FIG. 3.

FIG. 9 is a cross-sectional view illustrating an example internal structure of the baffle screw in the water-cooling system.

FIG. 10 is view schematically illustrating an example of a circulation path through which cooling water flows between the baffle screw and the inner periphery of the cooling channel in the water-cooling system.

FIG. 11 is a block diagram illustrating an example of a drive module in the water-cooling system.

### DETAILED DESCRIPTION

Hereinafter, one or more implementations of the present disclosure will be described in detail with the accompanying drawings.

In the present disclosure, the first direction X, second direction Y, and third direction Z described herein respectively refer to the dimensions on a three-dimensional coordinate system used to express a three-dimensional shape and the directionality assigned to each dimension. Therefore, the first direction X, the second direction Y, and the third direction Z may be represented by arrows that intersect each other perpendicularly at a point in space.

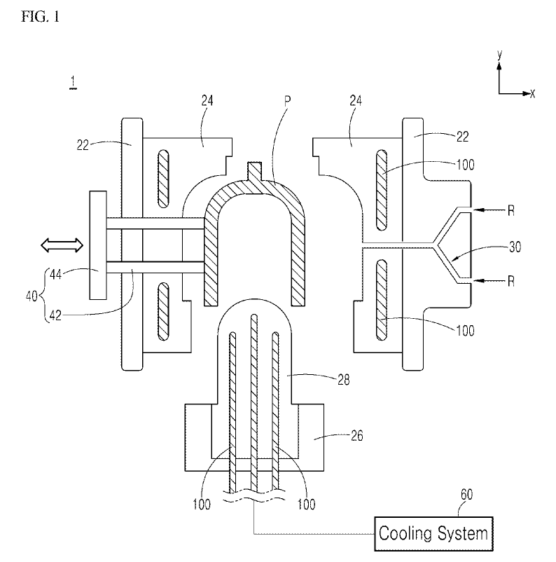

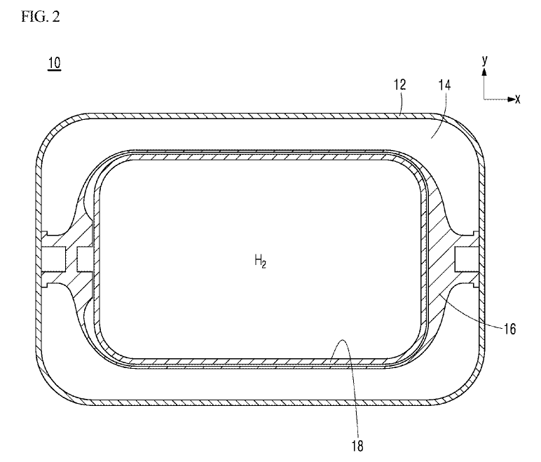

FIG. 1 is a view schematically illustrating an example of an injection molding apparatus 1, and FIG. 2 is a schematic cross-sectional view illustrating an example o structure of a hydrogen tank 10 installed in a hydrogen vehicle.

In some implementations, as illustrated in FIG. 1, the injection molding apparatus 1 may be used for a mass-production of injection-molded products. For example, the injection molding apparatus 1 produces an injection-molded product P by melting a raw material, injecting the molten raw material into a molding mold, and then cooling and solidifying the injected raw material.

The injection molding apparatus 1 may include an injection unit, the molding mold, a gate 30, an ejector 40, and a cooling system 60.

In some examples, the injection unit may include a hopper that stores and provides raw materials, a heater that heats the raw materials and transforms them into a molten material R, and an injector that pushes the molten material R into a nozzle provided in the molding mold. The injection unit prepares the molten material R and injects the molten material R into the molding mold.

The molding mold may be made of a plurality of molds, such as a first mold 22 and a second mold 26.

Each mold may be provided to be movable or may be installed to be fixed.

Referring to the drawing, the first mold 22 may be provided with two molds that move laterally, and the first mold 22 is equipped with a cavity mold 24. The cavity mold 24, together with the base core 28, defines a predetermined space to shape the exterior of the injection-molded product P.

In particular, the cavity mold 24 refers to a die that shapes the exterior of the injection-molded product P.

A base core 28 is mounted in the second mold 26. The base core 28, together with the cavity mold 24, defines a predetermined space for shaping the exterior of the injection-molded product P.

In addition, the base core 28 refers to a die that shapes the interior of the injection-molded product P.

The first mold 22 and/or the second mold 26 may each be provided to be fixed or movable.

In addition, a cooling channel 100 may be formed in each of the first mold 22 and/or the second mold 26, the cavity mold 24, and the base core 28.

The cooling channel 100 is a flow path formed inside each of the first mold 22, the second mold 26, the cavity mold 24, and the base core 28, and is formed straight. One end of the cooling channel 100 is configured as a channel inlet opening to the outside of each of the first mold 22, the second mold 26, the cavity mold 24, and the base core 28, and the other end of the cooling channel 100 is formed straight and long from the channel inlet in each of the first mold 22, the second mold 26, the cavity mold 24, and the base core 28 toward the space where the injection-molded product P is placed. The other end of the cooling channel 100 is configured as a closed-ended transition section located adjacent to the space where the injection-molded product P is placed.

The gate 30 is a path that allows the molten material R to pass through the molding mold and the cavity mold 24 or the molding mold and the base core 28, and then flow into a predetermined space provided by the cavity mold 24 and the base core 28.

The ejector 40 may include multiple extraction pins 42 and an extraction unit 44, and the ejector 40 separates the injection-molded product P solidified after cooling from the cavity mold 24 and the base core 28.

The extraction unit 44 is configured to move linearly, and as the extraction unit 44 moves, the multiple extraction pins 42 may push the injection-molded product P out through the molding mold and the cavity mold 24, or the molding mold and the base core 28.

The water-cooling system 60 circulates cooling water through the cooling channel 100 formed in at least one of the first mold 22, the second mold 26, the cavity mold 24, and the base core 28. The water-cooling system 60 cools the first mold 22, the second mold 26, the cavity mold 24, and the base core 28 located adjacent to the cooling channel 100 through the circulation of cooling water.

In some implementations, multiple cooling channels 100 may be provided, and the first mold 22, the second mold 26, the cavity mold 24, the base core 28, and the like, in which the cooling channels 100 can be formed, are collectively referred to as the "molding mold."

As shown in FIG. 2, the injection molding apparatus 1 may be used to manufacture a liner 16 of a hydrogen tank 10.

This is an illustrative example, and the present disclosure may be implemented to manufacture various plastic injection-molded products P, and the scope of application of the present disclosure is not limited to an apparatus for manufacturing a liner 16 for a hydrogen tank 10.

Briefly, the hydrogen tank 10 mounted on a hydrogen vehicle may include an inner shell 18 which is a container configured to store hydrogen, a liner 16 configured to surround and protect the outer perimeter of the inner shell 18, an outer shell 12 defining predetermined space with the liner 16 and configured to surround and protect the exterior of the liner 16, and a reinforcement layer 14 filled with a composite material between the liner 16 and the outer shell 12.

Among these, the liner 16 is made of a material with excellent chemical stability and pressure resistance to prevent hydrogen from leaking to the outside.

In addition, as the size of the hydrogen tank 10 increases, the liner 16 applied to the hydrogen tank 10 may also be manufactured in a larger size.

In some examples, to manufacture the liner 16 of the large hydrogen tank 10, a relatively large molding mold is used. In some cases, as the volume of the molding mold increases, the cooling efficiency of the injection-molded product P decreases.

Accordingly, the injection molding apparatus 1 includes a water-cooling system 60 that is capable of shortening the production cycle and improving the quality of a product even when manufacturing the liner 16 of the large hydrogen tank 10.

Below, the water-cooling system 60 will be described.

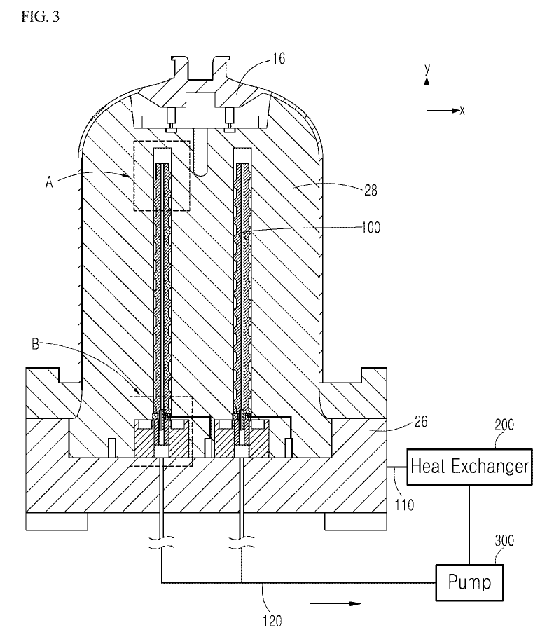

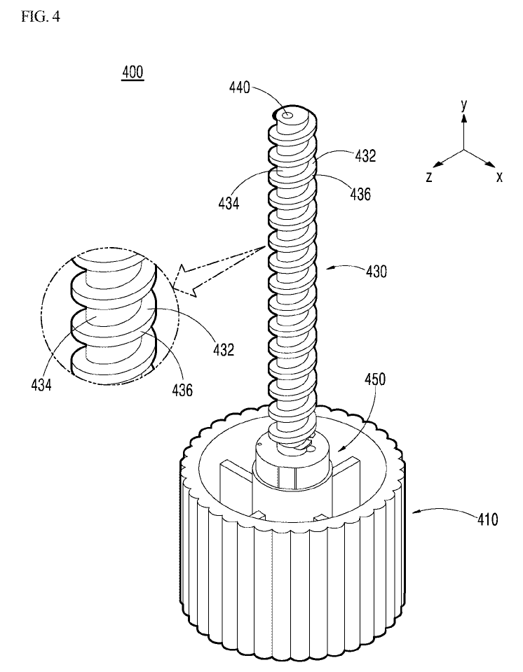

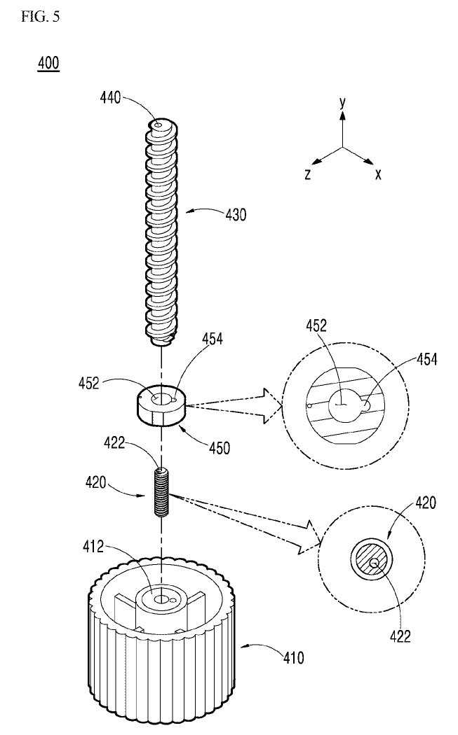

FIG. 3 is a cross-sectional view illustrating a water-cooling system 60, FIG. 4 is a perspective view illustrating a baffle module 400 in the water-cooling system 60, and FIG. 5 is an exploded perspective view of the baffle module 400 in the water-cooling system 60.

As illustrated in FIGS. 3 to 5, the water-cooling system 60 performs cooling by circulating cooling water inside the molding mold.

The molding mold may be at least one of the first mold 22, the second mold 26, the cavity mold 24, and the base core 28.

To this end, the water-cooling system 60 may include a cooling channel 100, a coolant supply pipe 110, a coolant recovery pipe 120, and a baffle module 400.

The cooling channel 100 is a series of paths through which cooling can be supplied into the molding mold.

Multiple cooling channels 100 may be provided in the molding mold to have different paths, respectively.

Each cooling channel 100 has a channel inlet that opens toward the outside of the molding mold, in which each cooling channel 100 is provided, based on the space defined by the cavity mold 24 and the base core 28.

The channel inlet is the entrance to the passage formed by the cooling channel 100, wherein the cooling channel 100 is a passage formed straight from the channel inlet and is formed to have a straight path from the channel inlet toward the predetermined space defined by the cavity mold 24 and the base core 28.

The other end of the cooling channel 100, which is opposite to the channel inlet, has a closed structure. The other end, where the flow path is closed, is provided adjacent to the space defined between the cavity mold 24 and the base core 28, and serves as a transition section where the cooling water flowing into the cooling channels 100 has a great influence on the cooling of the injection-molded product P.

The coolant supply pipe 110 is a passage that supplies cooling water cooled to a predetermined temperature via a heat exchanger 200 to the cooling channels 100.

The coolant recovery pipe 120 is a passage through which the cooling water that has flowed into the cooling channels 100 is recovered, the cooling water recovered through the coolant recovery pipe 120 is supplied back to the heat exchanger 200 through a pump 300 for cooling, and the cooling water that has passed through the heat exchanger 200 may be injected again into the cooling channels 100 through the coolant supply pipe 110.

That is, the cooling water can be repeatedly circulated through the coolant recovery pipe 120, the pump 300, the heat exchanger 200, the coolant supply pipe 110, and the cooling channels 100.

A baffle module 400 is installed in each cooling channel 100 formed inside the molding mold.

The baffle module 400 divides the space inside the cooling channel 100 and configures a circulation path along which the cooling water moves within the cooling channel 100. In addition, the baffle module 400 allows cooling water to circulate more smoothly inside the cooling channel 100.

Specifically, the baffle module 400 may include a drive module 500, a coupling housing 450, a power transmission pin 420, and a baffle screw 430.

The drive module 500 may be a drive motor 410 that converts electrical energy into kinetic energy, particularly rotational force. The drive motor 410 may include at the center thereof a drive shaft 412 that is rotatable in one direction, and in response to the rotation of the drive shaft 412, the baffle screw 430 accommodated inside the cooling channel 100 may rotate in unison.

The coupling housing 450 is a disk-shaped member and may be coupled to the channel inlet of the cooling channel 100 to close the cooling channel 100.

The coupling housing 450 separates the space inside the cooling channel 100 from the outside and prevents the cooling water circulating inside the cooling channel 100 from leaking to the outside through the channel inlet.

The coupling housing 450 is fixed to the molding mold configuring the channel inlet. In addition, the coupling housing 450 may be provided with a pin passing hole 452 and a coolant connection path 454. The pin passing hole 452 and the coolant connection path 454 are openings formed in the coupling housing 450. The pin passing hole 452 and the coolant connection path 454 may be partially connected to each other, or may be provided as separate holes.

The pin passing hole 452 is formed vertically across the center of the coupling housing 450.

In the space where the pin passing hole 452 is formed, power transmission pin 420 may be arranged vertically across the space.

The lower end of the power transmission pin 420 is coupled with the drive module 500 or the drive shaft 412, causing the power transmission pin 420 to rotate in unison in response to the rotation generated by the drive module 500.

A threaded coupling structure may be provided around the outer periphery of the power transmission pin 420.

In addition, the power transmission pin 420 is installed so as not to be in contact with the pin passing hole 452 provided in the coupling housing 450. For this purpose, a bearing member to reduce friction may be further provided between the coupling housing 450 and the drive module 500, and between the coupling housing 450 and the power transmission pin 420. The bearing member may be further provided in an appropriate form, so that the configurations such as the fixed molding mold, the inner periphery of the cooling channel 100, and the coupling housing 450, and the configurations that rotate via the drive module 500 such as the power transmission pin 420 and the baffle screw 430 do not interfere with each other.

The power transmission pin 420 may have a cylindrical shape extending long along an imaginary straight line parallel to the Y-axis direction with reference to the drawing. A thread may be formed on the outer periphery of the power transmission pin 420, and an extension discharge path 422 may be provided therein as a vertically extending passage.

The extension discharge path 422 serves as a passage through which the cooling water discharged from the inside of the cooling channel 100 to the coolant recovery pipe 120 passes.

At least a portion of the upper end (the other end) of the power transmission pin 420 is accommodated into the cooling channel 100 across the pin passing hole 452. The upper end of the power transmission pin 420 may be coupled to the lower end (one end) of the baffle screw 430, so that the rotational force generated by the drive module 500 can be transmitted to the baffle screw 430 via the power transmission pin 420.

Specifically, the upper end of the power transmission pin 420 may be coupled to the lower end portion of the discharge hole 440 vertically formed inside the baffle screw 430 along the longitudinal direction (the Y-axis direction) of the baffle screw 430.

The power transmission pin 420 and the baffle screw 430 may be cylindrical members extending long along the Y-axis direction, and the centers of the power transmission pin 420 and the baffle screw 430 may coincide with each other. In addition, the power transmission pin 420 and the baffle screw 430 rotate around the same rotation axis.

Inside the baffle screw 430, an opening provided in the vertical direction configures the discharge hole 440 as a flow path through which the cooling water discharged from the cooling channel 100 to the coolant recovery pipe 120 passes.

The discharge hole 440 and the extension discharge path 422 are arranged so that the respective flow paths thereof are connected to each other.

The baffle screw 430 may have a thread peak 432 protruding spirally along its outer periphery in one direction.

A thread valley 434 is provided relatively concavely between the thread peaks 432.

In addition, a thread contact surface 436, which is a spiral curved surface in contact with the inner periphery of the cooling channel 100, is provided at the outermost portion of the thread peak 432.

Therefore, inside the cooling channel 100, a cooling water supply path, which is the space defined between the baffle screw 430 and the inner periphery of the cooling channel 100, is provided spirally along the thread valley 434 formed on the outer periphery of the baffle screw 430.

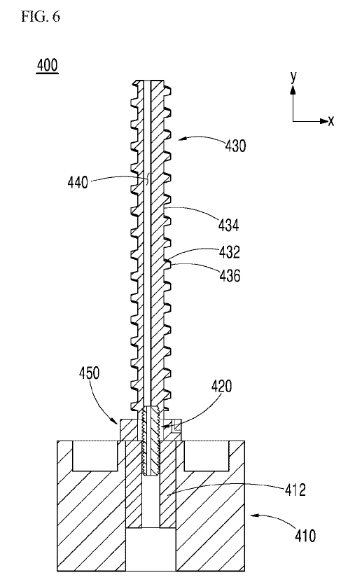

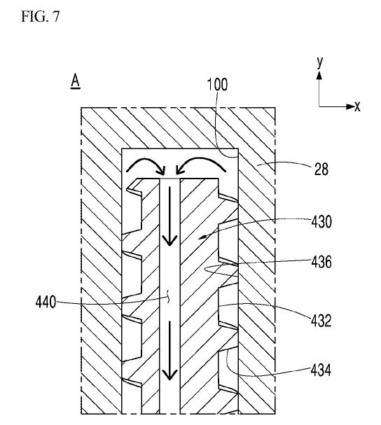

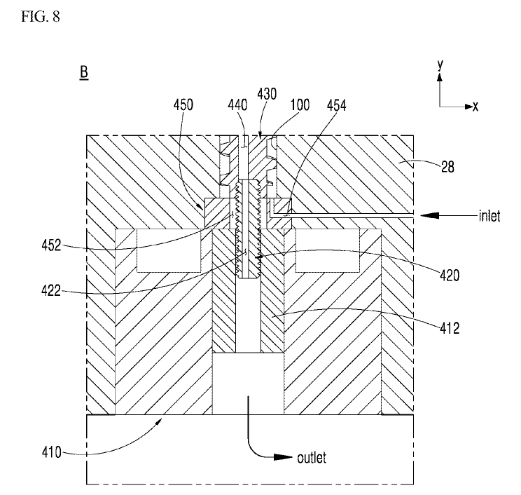

FIG. 6 is a cross-sectional view of the baffle module 400 in the water-cooling system 60, FIG. 7 is a partial enlarged view of the portion A in FIG. 3, and FIG. 8 is a partial enlarged view of the portion B in FIG. 3.

As illustrated in FIGS. 6 to 8, the power transmission pin 420 and the baffle screw 430 can be rotated about a rotation axis parallel to the Y axis by the drive module 500.

When the baffle screw 430 rotates inside the cooling channel 100, the cooling water moves along the inclined path provided by the thread peak 432 and the thread valley 434.

In some implementations, the baffle screw 430 rotates clockwise with reference to the drawing, and the cooling water flowing into the space between the baffle screw 430 and the inner periphery of the cooling channel 100 rotates and rises in the +Y-axis direction.

The coolant connection path 454 provided in the coupling housing 450 may have one end connected to the coolant supply pipe 110 and the other end provided inside the cooling channel 100. According to the rotation of the baffle screw 430, the cooling water flowing into the cooling channel 100 through the coolant connection path 454 rises along the thread valley 434 formed on the outer periphery of the baffle screw 430 while rotating in the direction opposite to the rotating direction of the baffle screw 430.

As illustrate in FIG. 7, in the transition section provided adjacent to the injection-molded product P inside the cooling channel 100, the flow of cooling water that rose along the thread valley 434 is redirected. In the transition section, cooling water flows into the discharge hole 440 formed in the center of the baffle screw 430.

The cooling water flows into the discharge hole 440 from the transition section and is discharged to the outside of the cooling channel 100 via the discharge hole 440 and the extension discharge path 422. Then, the cooling water is collected in the coolant recovery pipe 120 through a separately provided path.

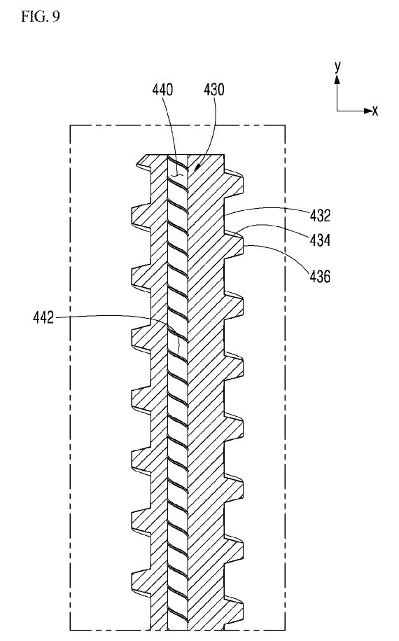

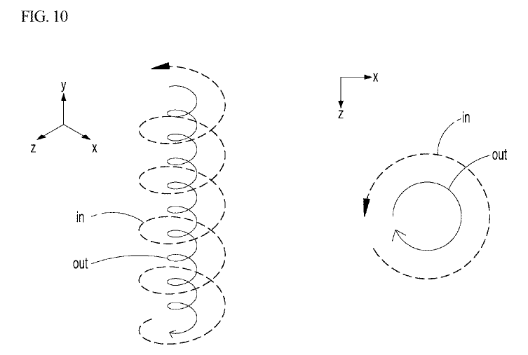

FIG. 9 is a cross-sectional view illustrating the internal structure of the baffle screw 430 in the water-cooling system 60, and FIG. 10 is view schematically illustrating the circulation path through which cooling water flows between the baffle screw 430 and the inner periphery of the cooling channel 100 in the water-cooling system 60.

As illustrated in FIG. 9, a spiral guide 442 that rotates spirally may be provided on the inner periphery of the discharge hole 440.

The spiral guide 442 is formed in a spiral shape inclined in the opposite direction to the slope formed by the thread valley 434.

In some examples, the spiral guide 442 may be provided as a relatively long spiral groove (or protruding wall) formed as a path that rotates spirally along the vertically elongated circular passage formed by the discharge hole 440.

As shown in FIG. 10, the cooling water supplied to the cooling channel 100 may rise while rotating counterclockwise along the thread valley 434 of the baffle screw 430 to reach the transition section, and in the transition section, the cooling water flowing into the discharge hole 440 at the upper end of the baffle screw 430 may be discharged through the spiral guide 442 while rotating clockwise.

The baffle screw 430 configures a predetermined cooling water circulation path in the space inside the cooling channel 100, and allows the cooling water moving along this circulation path to circulate more smoothly.

In some implementations, the vertical thickness of the thread valley 434 provided on the outer periphery of the baffle screw 430 may gradually become thinner from the lower end of the baffle screw 430 toward the transition section. That is, the width of the thread valley 434 may gradually increase toward the transition section.

This may induce the moving speed of the cooling water to be increased at a position relatively distant from the transition section, as the flow rate of the cooling water supplied at the same flow rate is inversely proportional to the cross-sectional area of the passage through which the cooling water flows.

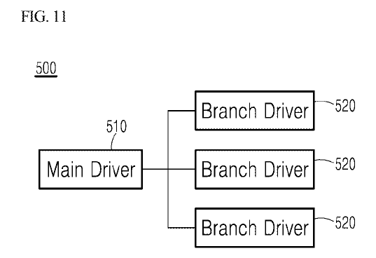

FIG. 11 is a block diagram illustrating the drive module 500 in the water-cooling system 60.

As illustrated in FIG. 11, the drive module 500 in the water-cooling system 60 may be implemented as a drive motor 410 equipped with a rotation shaft as described above. In some examples, the drive module 500 may be configured with multiple branch drivers 520 physically connected to a single main driver 510.

The main driver 510 may convert electrical energy into rotational energy, and the multiple branch drivers 520 may be connected to the main driver 510 via a configuration that may transmit a physical force, such as a gearbox.

That is, the multiple branch drivers 520 may be rotated via the single main driver 510. In addition, in the case where multiple baffle modules 400 are provided, each power transmission pin 420 may be physically coupled to the branch driver 520 outside the corresponding cooling channel 100 across the pin passing hole 452 provided in the coupling housing 450.

It is apparent to a person ordinarily skilled in the art that the present disclosure can be modified within the scope of the disclosed technical ideas. The described implementations should be considered as part of the present disclosure, and the scope of the present disclosure should not be determined solely by the described implementations.

The scope of the present disclosure should be determined based on the technical ideas described in the claims. Furthermore, even if the operations or effects according to configurations are not explicitly described while describing the implementations of the present disclosure, it is apparent that the predictable operations or effects based on the corresponding configurations should naturally be recognized as part of the present disclosure.

What is claimed is:

1. A water-cooling system for an injection-molding apparatus, the water-cooling system being configured to circulate cooling water to cool a molding mold, the water-cooling system comprising:
a cooling channel that defines a straight flow path inside the molding mold, the cooling channel having (i) a first end that defines a channel inlet opened toward an exterior of the molding mold and (ii) a second end that defines a transition section and is a closed end of the straight flow path, the straight flow path extending through at least a part of an interior of the molding mold toward an injection-molded product;
a coolant supply pipe configured to supply the cooling water to the cooling channel;
a coolant recovery pipe configured to receive the cooling water from the cooling channel; and
a baffle module that is at least partially accommodated inside the cooling channel and defines a circulation path in the cooling channel, the baffle module being configured to move the cooling water introduced through the coolant supply pipe along the circulation path and to discharge the cooling water to the coolant recovery pipe,
wherein the baffle module comprises a baffle screw that has a cylindrical shape and is accommodated inside the cooling channel along the straight flow path of the cooling channel, the baffle screw comprising a plurality of thread peak portions that protrude in an oblique direction from an outer periphery of the baffle screw, and
wherein the baffle screw is configured to rotate inside the cooling channel to thereby move the cooling water along a predetermined path.

2. The water-cooling system of claim 1, wherein the baffle screw further comprises:
a thread contact surface that defines a curved surface spirally extending along an outermost periphery of the plurality of thread peak portions, the thread contact surface being in contact with an inner periphery of the cooling channel; and
a thread valley portion that is a groove defined between the plurality of thread peak portions, the thread valley portion defining a spiral flow path between the baffle screw and the inner periphery of the cooling channel.

3. The water-cooling system of claim 1, wherein the baffle screw defines a discharge hole inside the baffle screw, the discharge hole extending along a longitudinal direction of the baffle screw, and
wherein the discharge hole provides a flow path that connects opposite ends of the baffle screw to each other.

4. The water-cooling system of claim 3, further comprising:
a drive module provided outside the cooling channel and configured to generate rotational force,
wherein the baffle module further comprises:
a coupling housing that is configured to close the channel inlet, the coupling hosing defining a pin passing hole and a coolant connection path; and
a power transmission pin comprising (i) a first end coupled to the drive module and (ii) a second end that passes through the pin passing hole and is coupled to the baffle screw accommodated inside the cooling channel, the power transmission pin being configured to transmit the rotational force from the drive module to the baffle screw.

5. The water-cooling system of claim 4, wherein the power transmission pin defines an extension discharge path inside the power transmission pin along the longitudinal direction, and
wherein the second end of the power transmission pin is coupled to an end of the baffle screw facing outward of the cooling channel, the extension discharge path being connected to the discharge hole of the baffle screw.

6. The water-cooling system of claim 4, wherein the coolant connection path is connected to the coolant supply pipe and is configured to guide the cooling water supplied from the coolant supply pipe into the cooling channel.

7. The water-cooling system of claim 4, wherein the baffle screw further comprises a spiral guide that is a spiral groove along an inner periphery of the discharge hole, and
wherein a spiral direction of the spiral guide is opposite to a spiral direction of the plurality of thread peak portions.

8. The water-cooling system of claim 4, wherein the drive module comprises:
a main driver configured to convert electrical energy into kinetic energy including the rotational force; and
a plurality of branch drivers connected to the main driver and configured to receive the rotational force generated by the main driver,
wherein the baffle module is one of a plurality of baffle modules of the water-cooling system, and
wherein one end of the power transmission pin of each of the plurality of baffle modules is coupled to a corresponding one of the plurality of branch drivers and configured to be rotated by the rotational force generated by the main driver.

9. The water-cooling system of claim 1, wherein the injection-molding apparatus comprises:
a plurality of water-cooling systems that are provided in the molding mold and include the water-cooling system;
the molding mold, the molding mold comprising (i) a cavity mold configured to shape an external shape of the injection-molded product and (ii) a base core configured to shape an internal shape of the injection-molded product;
a gate that defines a passage configured to receive a molten raw material injected into a space defined between the cavity mold and the base core; and
an ejector configured to separate the injection-molded product from the molding mold.

10. An injection-molding apparatus comprising:
a molding mold comprising (i) a cavity mold configured to shape an external shape of an injection-molded product and (ii) a base core configured to shape an internal shape of the injection-molded product;
a gate that defines a passage configured to receive a molten raw material injected into a space defined between the cavity mold and the base core;
an ejector configured to separate the injection-molded product from the molding mold; and
a plurality of water-cooling systems that are provided in the molding mold, each of the plurality of water-cooling systems comprising:
a cooling channel that defines a straight flow path inside the molding mold, the cooling channel having (i) a first end that defines a channel inlet opened toward an exterior of the molding mold and (ii) a second end that defines a transition section and is a closed end of the straight flow path, the straight flow path extending through at least a part of an interior of the molding mold toward the injection-molded product,
a coolant supply pipe configured to supply the cooling water to the cooling channel,
a coolant recovery pipe configured to receive the cooling water from the cooling channel, and
a baffle module that is at least partially accommodated inside the cooling channel and defines a circulation path in the cooling channel, the baffle module being configured to move the cooling water introduced through the coolant supply pipe along the circulation path and to discharge the cooling water to the coolant recovery pipe,
wherein the baffle module comprises a baffle screw that has a cylindrical shape and is accommodated inside the cooling channel along the straight flow path of the cooling channel, the baffle screw comprising a plurality of thread peak portions that protrude in an oblique direction from an outer periphery of the baffle screw, and
wherein the baffle screw is configured to rotate inside the cooling channel to thereby move the cooling water along a predetermined path.

11. The injection-molding apparatus of claim 10, wherein the baffle screw further comprises:
a thread contact surface that defines a curved surface spirally extending along an outermost periphery of the plurality of thread peak portions, the thread contact surface being in contact with an inner periphery of the cooling channel; and
a thread valley portion that is a groove defined between the plurality of thread peak portions, the thread valley portion defining a spiral flow path between the baffle screw and the inner periphery of the cooling channel.

12. The injection-molding apparatus of claim 10, wherein the baffle screw defines a discharge hole inside the baffle screw, the discharge hole extending along a longitudinal direction of the baffle screw, and
wherein the discharge hole provides a flow path that connects opposite ends of the baffle screw to each other.

13. The injection-molding apparatus of claim 12, further comprising:
a drive module provided outside the cooling channel and configured to generate rotational force,
wherein the baffle module further comprises:
a coupling housing that is configured to close the channel inlet, the coupling hosing defining a pin passing hole and a coolant connection path; and
a power transmission pin comprising (i) a first end coupled to the drive module and (ii) a second end that passes through the pin passing hole and is coupled to the baffle screw accommodated inside the cooling channel, the power transmission pin being configured to transmit the rotational force from the drive module to the baffle screw.

14. The injection-molding apparatus of claim 13, wherein the power transmission pin defines an extension discharge path inside the power transmission pin along the longitudinal direction, and
wherein the second end of the power transmission pin is coupled to an end of the baffle screw facing outward of the cooling channel, the extension discharge path being fluidly connected to the discharge hole of the baffle screw.

15. The injection-molding apparatus of claim 13, wherein the coolant connection path is connected to the coolant supply pipe and is configured to guide the cooling water supplied from the coolant supply pipe into the cooling channel.

16. The injection-molding apparatus of claim 13, wherein the baffle screw further comprises a spiral guide that is a spiral groove along an inner periphery of the discharge hole, and
wherein a spiral direction of the spiral guide is opposite to a spiral direction of the plurality of thread peak portions.

17. The injection-molding apparatus of claim 13, wherein the drive module comprises:
a main driver configured to convert electrical energy into kinetic energy including the rotational force; and
a plurality of branch drivers connected to the main driver and configured to receive the rotational force generated by the main driver, and
wherein one end of the power transmission pin of each of the plurality of baffle modules is coupled to a corresponding one of the plurality of branch drivers and configured to be rotated by the rotational force generated by the main driver.
